(19) United States
(12) Patent Application Publication
(10) Pub. No.: US 2010/0310713 A1
(43) Pub. Date: Dec. 9, 2010

(54) PROBIOTIC COMPOSITION

(75) Inventors: Christer Viebke, Bussum (NL); Callaghan Flynn, Moyvane (IE)

Correspondence Address: FOLEY HOAG, LLP;PATENT GROUP, WORLD TRADE CENTER WEST, 155 SEAPORT BLVD, BOSTON, MA, 02110, US

(73) Assignee: Kerry Group Services International Limited, County Kerry (IE)

(21) Appl. No.: 12/679,171

(22) PCT Filed: Sep. 5, 2008
(86) PCT No.: PCT/EP2008/061829

§ 371 Date: Aug. 18, 2010

(30) Foreign Application Priority Data
Sep. 21, 2007 (IE) S2007/0683

(51) Int. Cl. A23L 1/28

(52) U.S. Cl. 426/7; 426/61

(57) ABSTRACT

A probiotic composition comprising a probiotic culture having a probiotic count of between 10⁶ and 10¹⁰ cfu/ml or cfu/g and a carrier medium is disclosed. The invention also relates to a process for preparing the probiotic composition and to probiotic beverage and food products comprising the probiotic composition.

### INTRODUCTION

The present invention relates to a probiotic composition comprising a probiotic culture having a probiotic count of between 10⁶ and 10¹⁰ cfu/ml or cfu/g and a carrier medium. The invention also relates to a process for preparing the probiotic composition and to probiotic beverage and food products comprising the probiotic composition.

In the specification, the term “probiotic culture” refers to a population of live microorganisms which beneficially affect a host by improving its intestinal microbial balance. In the specification the term “by weight” refers to the weight of the probiotic composition unless otherwise specified.

Probiotic compositions comprising probiotic cultures are well known and include food and beverage products such as probiotic yoghurts and yoghurt drinks. Generally, in order for a product to be considered probiotic, the probiotic culture at the time of consumption should have a probiotic count of at least 10⁶ cfu/ml or cfu/g, and preferably between 10⁷ and 10⁹ cfu/ml or cfu/g. The specific probiotic requirements are also dependent on the type of probiotic culture. If the probiotic viability of the product is reduced, then the product cannot claim to have probiotic capability.

The main problem with probiotic products however is the survival of the cultures over the shelf life of the product. Presently, in order to ensure that there is sufficient probiotic viability in a product, the product must be of a certain type or must be kept under certain conditions to guarantee a high survival rate of the culture. Probiotic bacteria are sensitive to many environmental factors such as pH, temperature, moisture, air (oxygen), and light, and this limits the type of food and beverage products which can be used to carry the probiotic cultures.

In the case of pH, most probiotic cultures will only remain viable in products having a pH of between 4.5 and 8, and thus the type of food and beverage products suitable for conversion into probiotic products is limited. Additionally, the recommended shelf-life of that product may need to be reduced to take into account the presence of the probiotics, thus having cost implications for manufacturers.

Furthermore, even for any food or beverage products which can maintain probiotic cultures, certain specific manufacturing steps must be carried out in order to protect the cultures. These manufacturing processes include encapsulation and freeze drying of the culture and lead to an increase in the cost of manufacture of the product as well as lengthening the manufacturing process.

Thus there is a need for a probiotic composition which can maintain viability under a wider range of conditions and a process for preparing such a probiotic composition. There is further a need for a probiotic food and beverage product which has an extended shelf life and maintains probiotic capability during its shelf life.

### STATEMENTS OF INVENTION

According to the invention, there is provided a probiotic composition comprising a probiotic culture having a probiotic count of between 10⁶ and 10¹⁰ cfu/ml or cfu/g and a carrier medium;
characterised in that:
the probiotic composition further comprises between 0.1% and 99.9% gum Arabic by weight.

It has surprisingly been found that the addition of gum Arabic to the probiotic composition provides protection for the probiotic culture. This has been found to increase both the survival rate and viability of the probiotic culture either within the composition or after being added to a food or beverage product thus resulting in an extended shelf life for the product. Additionally, due to the increased viability of the culture, it has been found that the inoculum level of the culture can be decreased during manufacture of the product. This will still result in a viable count of probiotic culture, and will also lead to associated cost advantages. As the probiotic culture has increased stability in the products the manufacturing step of forming an encapsulated probiotic culture using spray or freeze-drying can generally be obviated thus resulting in further associated cost advantages.

It has also been found that in comparison with other hydrocolloids, gum Arabic has the ability to attach itself more easily to microorganisms. This is thought to be due to a protein part within the gum Arabic structure which most other hydrocolloids do not have and which results in the gum Arabic having higher surface activity than other hydrocolloids. Additionally, the structure of gum arabic is more compact compared with other hydrocolloids. Thus, from an energy point of view it will cost less for the gum arabic molecule to attach itself and remain attached to the surface of the microorganism.

When attached to the probiotic microorganisms, the gum arabic can act as a barrier and can prevent the diffusion of certain compounds into the cells of the microorganisms. This allows the probiotic cultures to remain viable under low pHs. It has also been found that the gum Arabic can change the chemistry of the organic acids

In one embodiment of the invention, the gum Arabic has a viscosity in the region of between 20 and 200 cP at 25% (w/w) solution and 25° C. in an aqueous solution as measured at a shear rate of between 0.1 s⁻¹ and 1000 s⁻¹.

In one embodiment of the invention, the carrier medium is selected from the group comprising one or more of MRS broth, mMRS solution, and water and the gum Arabic is in the amount of between 30% and 99% by weight.

In this embodiment of the invention, the probiotic composition is suitable for addition to a beverage or food product having a pH of 4 or less than 4 in an amount sufficient to provide between 0.1% and 10% gum Arabic by weight of the product.

In this embodiment of the invention, the probiotic composition is suitable for addition to a beverage or food product in an amount sufficient to provide between 0.5% and 5% gum Arabic by weight.

In another embodiment of the invention, the carrier medium is a beverage or food product having a pH of 4 or less than 4 and the gum Arabic is in the amount of between 0.1 and 10% by weight.

In this embodiment of the invention, the gum Arabic is in the amount of between 0.5 and 5% by weight.

The increased stability of the cultures enables them to be included in foods which are not generally suitable for probiotic cultures. In particular it has been found that the probiotic cultures contained within the probiotic composition of the present invention remain stable under low pHs and in particular pHs of 4 or less than 4. Thus the probiotic composition of the invention has extended the range of food or beverage products which can be inoculated with probiotic cultures.

Ideally, wherein the probiotic culture has a probiotic count of between 10⁷ and 10⁹ cfu/ml or cfu/g.

Preferably, the probiotic culture is selected from the group comprising one or more of Bifidobacterium animalis, Bifidobacterium adolescentis, Bifidobacterium bifidum, Bifidobacterium breve, Bifidobacterium essensis, Bifidobacterium infantis, Bifidobacterium lactis, Bifidobacterium longum, Lactobacillus paracasei, Lactobacillus acidophilus, Lactobacillus delbrueckii subsp. bulgaricus, Lactobacillus casei, Lactobacillus crispatus, Lactobacillus johnsonii, Lactobacillus lactis, Lactobacillus fermentum, Lactobacillus plantarum, Lactobacillus rhamnosus, Lactobacillus reuteri, Lactobacillus salivarius, Lactobacillus amylovorus, Lactobacillus gasseri, Lactobacillus pentosaceus, Enterococcus faecalis, Enterococcus faecium, Pediococcus acidilactici, Propioniobacterium freundenreichii, Saccharomyces boulardii and Streptococcus thermophilus.

In another embodiment of the invention, the probiotic composition further comprises one or more of buffers, salts, sugars, polysaccharides and proteins.

According to the invention, there is also provided a probiotic beverage or food product comprising the probiotic composition of the invention.

In one embodiment of the invention, the probiotic beverage or food product has a pH of 4 or less than 4.

In another embodiment of the invention, the probiotic beverage or food product is selected from the group comprising one or more of fruit juices, fruit drinks, fruit juice, fruit drink or fruit containing products such as mixed fruit juice/dairy drinks, mixed fruit juice/non-dairy drinks, mixed fruit juice/dairy food products, mixed fruit juice/non-dairy food products, mixed fruit drink/dairy drinks, mixed fruit drink/non-dairy drinks, mixed fruit drink/dairy food products, mixed fruit drink/non-dairy food products, mixed fruit/dairy drinks, mixed fruit/non-dairy drinks, mixed fruit/dairy food products, mixed fruit/non-dairy food products.

According to the invention, there is further provided a process for preparing a probiotic composition comprising a probiotic culture having a probiotic count of between 10⁶ and 10¹⁰ cfu/ml or cfu/g and a carrier medium, the process comprising:
dissolving between 0.1% and 99.9% gum Arabic by weight in the carrier medium to provide a gum Arabic solution; and
adding the probiotic culture to the gum Arabic solution to provide the probiotic composition.

In one embodiment of the invention, the probiotic culture comprises harvested cells having a probiotic count of between 10⁶ and 10¹⁰ cfu/ml or cfu/g and the harvested cells are resuspended in the gum Arabic solution.

In another embodiment of the invention, the probiotic culture comprises a starter culture; and wherein the culture is grown in the gum Arabic solution to provide a probiotic count of between 10⁶ and 10¹⁰ cfu/ml or cfu/g.

In a further embodiment of the invention, the carrier medium is selected from the group comprising one or more of MRS broth, mMRS solution, and water.

In this embodiment of the invention, the probiotic composition is subsequently added to a food or beverage product having a pH of 4 or less than 4.

In a still further embodiment of the invention, the carrier medium is a beverage or food product having a pH of 4 or less than 4.

According to the invention, there is still further provided the use of gum Arabic to improve the viability of a probiotic culture in a composition having a pH of 4 or less than 4.

### BRIEF DESCRIPTION OF THE DRAWINGS

The invention will now be more clearly understood from the following description of some embodiments thereof given by way of example only with reference to the accompanying drawings, in which:

FIG. 1 depicts mean log cfu/ml of orange juice inoculated with Bb12 and stored at 4° C.;

FIG. 2 depicts pH of orange juice inoculated with Bb12 and stored at 4° C.;

FIG. 3 depicts mean log cfu/ml of orange juice inoculated with Bb12 and stored at 15° C.;

FIG. 4 depicts pH of orange juice inoculated with Bb12 and stored at 15° C.;

FIG. 5 depicts mean log cfu/ml of orange juice inoculated with 338 and stored at 4° C.;

FIG. 6 depicts pH of orange juice inoculated with 338 and stored at 4° C.;

FIG. 7 depicts mean log cfu/ml of orange juice inoculated with 338 and stored at 15° C.; and

FIG. 8 depicts pH of orange juice inoculated with 338 and stored at 15° C.

FIGS. 9 to 13 depict mean log cfu/ml (±SD) of Bb12 in orange juice with and without varying concentrations of EmulGold

FIGS. 14 to 18 depict pH (±SD) of orange juice inoculated with Bb12 with and without varying concentrations of EmulGold.

FIGS. 19 to 24 depict mean log cfu/ml of Bb12 (±SD) in orange juice with and without 3% w/v EmulGold and varying inoculation levels of Bb12.

FIGS. 25 to 30 depict pH (±SD) of orange juice with and without 3% w/v EmulGold, inoculated with varying levels of Bb12.

FIG. 31 depicts log cfu/ml (±SD) of Bb12 in apple juice with and without 1.3% w/v EmulGold.

FIG. 32 depicts pH (±SD) of apple juice inoculated with Bb12 with and without 1.3% w/v EmulGold.

FIG. 33 depicts mean log cfu/ml (±SD) of Bb12 in cranberry juice with and without 1.3% w/v EmulGold.

FIG. 34 depicts pH (±SD) of cranberry juice inoculated with Bb12 with and without EmulGold.

FIG. 35 depicts mean log cfu/ml (±SD) of Bb12 in orange juice, apple juice and cranberry juice.

FIG. 36 depicts pH (±SD) of orange juice, apple juice and cranberry juice.

### DETAILED DESCRIPTION OF THE INVENTION

The probiotic composition of the present invention is prepared by dissolving gum Arabic in a carrier medium to provide a gum Arabic solution. Probiotic culture is then added to the gum Arabic solution to provide the probiotic composition.

Gum Arabic is a highly branched arabinogalactan and is generally available in the form of a powder and requires dissolution in the carrier medium prior to addition of the probiotic culture. Gum Arabic is also available in agglomerated or already dissolved forms. Gum Arabic can be selected from either Acacia Senegal or Acacia Seyal. Both types of gum Arabic have similar properties although there are slight differences in their sugar composition and molar mass.

The probiotic culture can either comprise harvested cells or a starter culture. The harvested cells can be prepared by routine culturing in a standard medium which can optionally be substituted with further nutrients. The cells are generally harvested by centrifugation and washed using a standard diluent such as Maximum Recovery Diluent (MRD). The cells can then be resuspended in MRD or other suitable type of diluent or medium. The gum Arabic solution is then inoculated with the cells so as to provide between 10⁶ and 10¹⁰ cfu/ml or cfu/g of probiotic culture per ml of gum Arabic solution and preferably between 10⁷ and 10⁹ cfu/ml or cfu/g. In the case where the probiotic culture is a starter culture this culture is then grown in the gum Arabic solution to provide a probiotic count in this range.

The probiotic culture could be any of Bifidobacterium animalis, Bifidobacterium adolescentis, Bifidobacterium bifidum, Bifidobacterium breve, Bifidobacterium essensis, Bifidobacterium infantis, Bifidobacterium lactis, Bifidobacterium longum, Lactobacillus paracasei, Lactobacillus acidophilus, Lactobacillus delbrueckii subsp. bulgaricus, Lactobacillus casei, Lactobacillus crispatus, Lactobacillus johnsonii, Lactobacillus lactis, Lactobacillus fermentum, Lactobacillus plantarum, Lactobacillus rhamnosus, Lactobacillus reuteri, Lactobacillus salivarius, Lactobacillus amylovorus, Lactobacillus gassed, Lactobacillus pentosaceus, Enterococcus faecalis, Enterococcus faecium, Pediococcus acidilactici, Propioniobacterium freundenreichii, Saccharomyces boulardii, Streptococcus thermophilus. It has been found that gum Arabic is particularly suited to the protection of the Bifidobacterium species.

The carrier medium used to dissolve the gum Arabic can be any type of food grade nutrient medium in the form of a liquid, aqueous based solution, semi-liquid or semi-solid which would allow dissolution of the gum Arabic. Such nutrient media include MRS broth, mMRS solution or water. Once dissolved in this carrier medium, the resultant probiotic composition can be added to any suitable type of beverage or food product thus producing a probiotic product.

The probiotic composition has been found to be particularly useful in preparing acidic probiotic beverage and food products and in particular probiotic beverage or food products having a pH of 4 or less than 4. This has extended the type of probiotic beverage or food products and these now include fruit juices, fruit drinks, fruit juice containing products, fruit drink containing products or fruit containing products such as mixed fruit juice/dairy drinks, mixed fruit juice/non-dairy drinks, mixed fruit juice/dairy food products, mixed fruit juice/non-dairy food products, mixed fruit drink/dairy drinks, mixed fruit drink/non-dairy drinks, mixed fruit drink/dairy food products, mixed fruit drink/non-dairy food products, mixed fruit/dairy drinks, mixed fruit/non-dairy drinks, mixed fruit/dairy food products, mixed fruit/non-dairy food products.

Alternatively, the carrier medium can itself be a beverage or food product. This beverage or food product can either be an acidic beverage or food product or can subsequently be added to an acidic beverage or food product as outlined above. If the carrier medium itself is a beverage or food product, suitable products have a pH of 4 or less than 4 and include fruit juices, fruit drinks, fruit juice containing products, fruit drink containing products or fruit containing products such as mixed fruit juice/dairy drinks, mixed fruit juice/non-dairy drinks, mixed fruit juice/dairy food products, mixed fruit juice/non-dairy food products, mixed fruit drink/dairy drinks, mixed fruit drink/non-dairy drinks, mixed fruit drink/dairy food products, mixed fruit drink/non-dairy food products, mixed fruit/dairy drinks, mixed fruit/non-dairy drinks, mixed fruit/dairy food products, mixed fruit/non-dairy food products.

The above beverage and food products would also include products such as fruit yoghurts and fruit yoghurt drinks, fruit smoothies, and any type of berry containing beverage or food product.

In the case where the carrier medium is a nutrient medium and the resultant probiotic composition is then added to a beverage or food product to provide a probiotic product. This product should generally have in the region of between 0.1% and 10%, and preferably between 0.5% and 5% gum Arabic by weight of the product. If the probiotic composition is being added to a beverage or food product it can generally be added at any stage during production and preferably after any heating or pasteurisation treatment.

Alternatively, if the carrier medium is a beverage or food product, the gum Arabic can be dissolved in this beverage or food product to provide the gum Arabic solution and the probiotic culture can either be resuspended or grown in this solution.

Optionally other components such as buffer, salts, sugars, polysaccharides, amino acids, proteins and vitamins can be added to the probiotic composition. The amounts added of each of these components would generally be as follows: buffer between 0.1% and 0.5%, salts between 10 ppm and 500 ppm, sugars between 5% and 20%, polysaccharides between 0.1% and 1%, amino acids and proteins between 0.1%-1.5% by weight of the beverage or food product and vitamins between 10-100% of the recommended daily intake (RDI) in a serving.

An example of a buffer which could be added includes sodium citrate or citric acid. The salts added could be any of sodium salts (e.g NaCl), potassium salts (e.g. KCl), or magnesium salts (e.g. MgCl₂). Examples of sugars could be dextrose, sucrose, fructose and inverted sugars. Examples of polysaccharides could be carrageenan, pectin, alginate, guar gum, carboxymethylcellulose, locust bean gum and xanthan gum. Any type of essential amino acid could be added such as isoleucine, glutamine, alanine, and cysteine. Suitable proteins would include any type of plant based or dairy based proteins, such as whey, casein, pea protein, wheat-protein and soy protein. Examples of vitamins would be Vitamin A, Thiamin (Vitamin B1), Riboflavin (Vitamin B2) and ascorbic acid (Vitamin C).

### EXAMPLES

### Example 1

Three probiotic compositions were prepared according to the invention, (treatments 1-3). A standard of orange juice comprising probiotic culture was also prepared, (treatment 4).

### Methods

### Orange Juice (OJ)

Kerry Ingredients supplied 12×1 litre cartons of Dawn “Juicy Bits” OJ. The cartons were shipped in a silver-foil wrapped box. Three cartons appeared to have a compromised seal and were discarded. All others where stored at 4° C. The day before the expiry date of the samples, 100 ml samples of OJ were added to 100 ml screw-cap Duran glass bottles. To a number of samples 3 g of gum Arabic was added directly and all samples were held at 4° C. overnight. The following day one of two probiotic cultures were added to the samples which were then stored in temperature controlled rooms held at 4° C. or 15° C.

Gum Arabic (GA)

EmulGold™ powder which is made from the species Acacia senegal was supplied in a screw-cap container with a total weight of approximately 1.5 kg. Both were stored at room temperature. EmulGold™ powder was added to OJ, mixed by hand and left at room temperature for 60 min before being stored at 4° C. Similarly powder was added to mMRS prior to inoculation with the probiotic cultures. No growth was noted in the GA+mMRS solution alone after 2 days incubation under anaerobic conditions at 37° C.

### Probiotic Cultures

Lactobacillus paracasei NFBC 338 and Bifidobacterium animalis subsp. lactis Bb12 were both routinely cultured in Lactobacilli MRS medium (Difco, USA) supplemented with 0.05% (w/v) cysteine-hydrochloride (mMRS) and grown at 37° C. in an anaerobic work chamber (Ruskin in vivo 400, set at 8% hydrogen, 8% carbon dioxide and 84% nitrogen). Colonies of each strain were cultured on mMRS agar and were used to inoculate 10 ml mMRS broths. Each culture was incubated for 20 hours and a 1% (v/v) inoculum was used to seed a 50 ml mMRS broth that was further incubated until the culture pH fell to between pH 3.9 to 4.2, which represented a growth period of approximately 20 hours. Previously cultures of this pH were found to yield cultures with cell densities of ˜2×10⁹ cfu/ml. Cells were harvested by centrifugation, washed in Maximum Recovery Diluent (MRD) and re-suspended in 10 ml MRD from which 1 ml was used to inoculate 100 ml OJ samples. This was estimated to yield ˜1×10⁸ cfu of probiotic culture per ml of OJ.

Four treatments were used, as follows;

Treatment 1, the probiotic cultures were grown in the presence of 3% (w/v) GA prior to their addition to the OJ samples.

Treatment 2, probiotic cultures were re-suspended in 50 ml MRD with 30% (w/v) GA and left at room temperature for 30 min, 8 ml was added to the OJ samples.

Treatment 3, probiotic cultures were added to OJ to which 3% (w/v) GA had been added.

Treatment 4, probiotic cultures were added to OJ.

For each treatment, six 100 ml OJ samples were prepared with three stored at 4° C. and 15° C., respectively.

Colony Forming Units (cfu) per ml of OJ

The cfu/ml was determined for a 1 ml sample of OJ following serial dilution in MRD and pour plating with mMRS. Colonies were counted after 3 days incubation. Each OJ sample was tested twice and a mean cfu/ml value calculated following sampling at 0, 7, 14, 21 and 28 days for strain 338 and 0, 6, 13, 19/20 and 27 days for strain Bb12. All statistical evaluations were based on the Student's t-Test (2-tail paired) and significances were measured at a probability level p<0.01.

### OJ pH

The pH of the OJ samples was determined using a Mettler Toledo pH meter calibrated prior to each series of measurements. At each time point ˜5 ml of OJ was taken and allowed to reach room temperature before a pH reading was taken.

### Results

B. animalis subsp. lactis Bb12

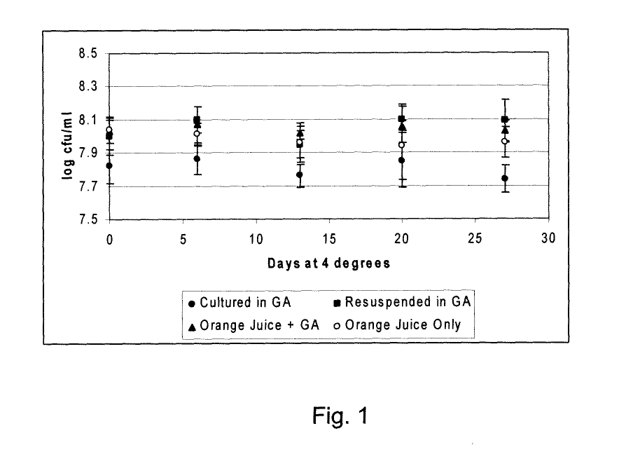

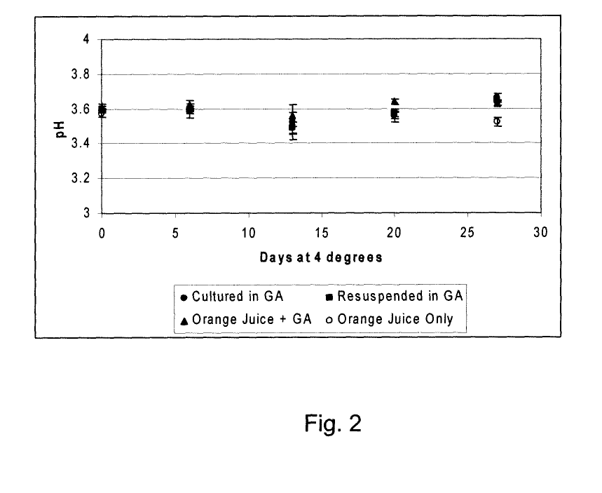

Following storage at 4° C. for 27 days there was no significant fall in strain viability in any of the OJ samples (Table 1a and FIG. 1). Statistically significant differences were observed between Treatment 1 and the other treatments but this is likely to represent differences in the initial inoculation levels with Treatment 1 being seeded from a separate mMRS culture that contained GA. The pH values did show statistically significant differences between time points but no trend was evident, rather an up and down variation was observed. Overall, the values were considered to be relatively constant throughout the 4 week period (Table 1b and FIG. 2).

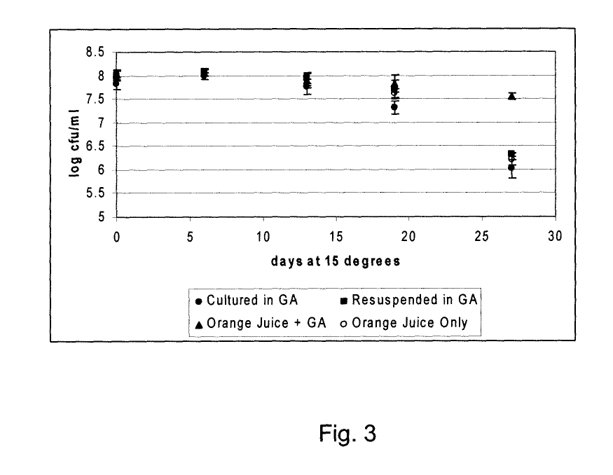

Following storage at 15° C. there was no significant fall in strain viability in any of the OJ samples for the first 13 days. However, at 19 days only OJ samples to which GA was added had cfu/ml values that were not significantly lower than those at day 0 (p<0.01) (Table 2a and FIG. 3). At 27 days all samples showed a significant decline in cfu/ml. However, for Treatment 3, which had GA added directly as a powder, the cfu/ml counts were significantly higher than for the other treatments (Table 2b and FIG. 3). In Treatment 2a 2.2% w/v GA level was achieved through the addition of a concentrated solution that was premixed with the probiotic culture. In Treatment 3a 3% w/v GA concentration was attained through the addition of GA as a powder.

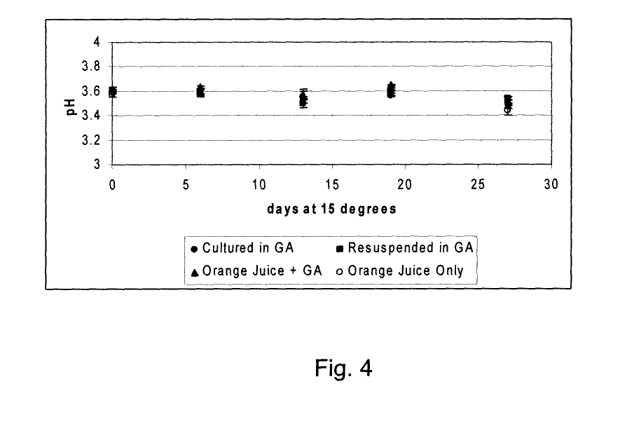

The pH values again showed some statistically significant differences. However, no clear trend was evident. There was a tendency for the values to be lower at the end of the trial and this may reflect the release of organic acid from non-viable cells (Table 2b and FIG. 4).

L. paracasei NFBC 338

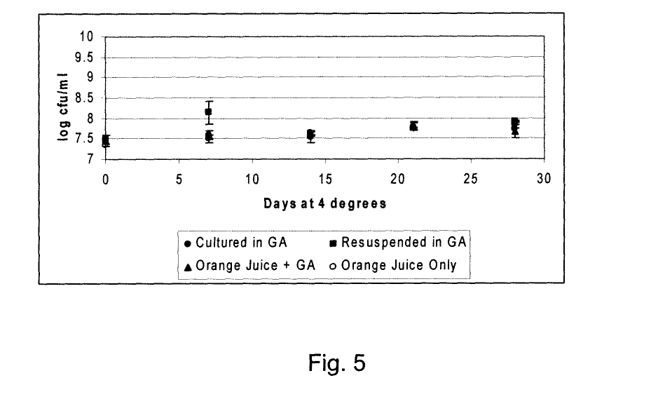

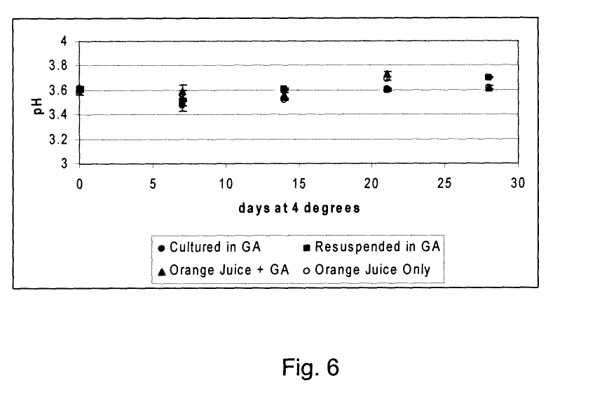

Following storage at 4° C. for 27 days there was no significant fall in strain viability in any of the OJ samples (Table 3a and FIG. 5). Indeed the statistically significant changes observed reflected a slight increase in cfu/ml during storage. This may have arisen through the disruption of cell chains and/or cell clumps which could change the cell to cfu relationship. Treatment 2 had a statistically significant higher cfu/ml at 7 days compared to the other treatments but this difference was not maintained over the next two sample points. The pH values did show statistically significant changes between time points and treatments but no trend was evident. Overall, the values were considered to be relatively constant (Table 4a and FIG. 6).

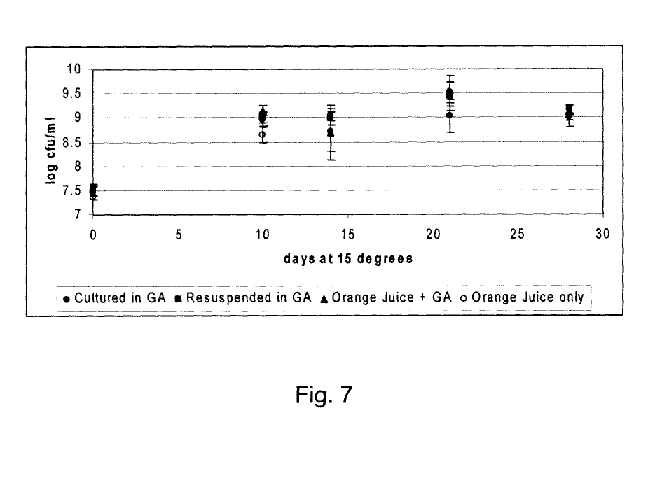

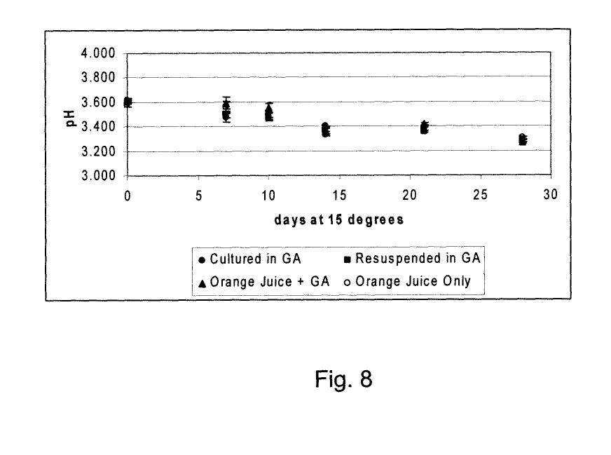

Following storage at 15° C. there was a significant rise in cfu/ml after 10 days which was maintained throughout the 4 week period in all of the treatments (Table 3b and FIG. 7). Because of apparent cell growth the initial plating dilutions at 7 days were not sufficient to established colony counts. The pH values showed some statistically significant differences with a trend showing a fall in pH during storage (Table 4b and FIG. 8). This may reflect the apparent growth of the culture during storage and the subsequent release of organic acids.

### CONCLUSION

This study showed that the inclusion of gum Arabic can significantly improve probiotic survival in orange juice during storage.

Tables. Values in the same column (representing different treatments) marked ^{A} were different to those marked ^{B} with a statistically significance of p<0.01. Similarly values marked ^{C} were different to those marked ^{D}. Values in the same row (representing the same treatment at different time points) with an * had statistically significant differences at p<0.01 compared to their respective 0 day value.

TABLE 1a
Mean log cfu/ml (± standard deviation) of orange juice inoculated
with Bb12 and stored at 4° C.

| | 0 days | 6 days | 13 days | 20 days | 27 days |
|---|---|---|---|---|---|
| Treatment 1 | 7.82 ± 0.10 | 7.86 ± 0.09 | 7.76 ± 0.07 | 7.85 ± 0.11 | 7.74 ± 0.08 |
| | | ^{A} | ^{A} | ^{A} | ^{A} |
| Treatment 2 | 8.00 ± 0.11 | 8.10 ± 0.08 | 7.94 ± 0.08 | 8.10 ± 0.08 | 8.09 ± 0.13 |
| | | ^{B}(p = 7E−4) | ^{B}(p = 4E−3) | ^{B}(p = 8E−4) | ^{B}(p = 2E−4) |
| Treatment 3 | 8.03 ± 0.06 | 8.07 ± 0.11 | 8.02 ± 0.04 | 8.06 ± 0.03 | 8.03 ± 0.06 |
| | | ^{B}(p = 1E−3) | ^{B}(p = 9E−5) | ^{B}(p = 9E−4) | ^{B}(p = 3E−5) |
| Treatment 4 | 8.04 ± 0.08 | 8.01 ± 0.07 | 7.96 ± 0.12 | 7.94 ± 0.25 | 7.96 ± 0.09 |
| | | ^{B}(p = 9E−3) | ^{B}(p = 7E−4) | | ^{B}(p = 1E−3) |

TABLE 1b
pH (± standard deviation) of orange juice inoculated with Bb12 and
stored at 4° C.

| | 0 days | 6 days | 13 days | 20 days | 27 days |
|---|---|---|---|---|---|
| Treatment 1 | 3.59 ± 0.01 | 3.59 ± 0.02 | 3.52 ± 0.06 | 3.56 ± 0.02 | 3.66 ± 0.03 |
| | | | | ^{B}(p = 4E−3) | ^{B}(p = 3E−3) |
| Treatment 2 | 3.60 ± 0.01 | 3.59 ± 0.04 | 3.49 ± 0.04 | 3.57 ± 0.02 | 3.64 ± 0.01 |
| | | | | ^{B}(p = 3E−3) | ^{B}(p = 1E−3) |
| Treatment 3 | 3.61 ± 0.02 | 3.62 ± 0.03 | 3.59 ± 0.06 | 3.64 ± 0.02 | 3.63 ± 0.02 |
| | | | | ^{A} | ^{B}(p = 4E−3) |
| Treatment 4 | 3.57 ± 0.02 | 3.60 ± 0.02 | 3.50 ± 0.07 | 3.56 ± 0.04 | 3.56 ± 0.03 |
| | | | | | ^{A} |

TABLE 2a
Mean log cfu/ml (± standard deviation) of orange juice inoculated
with Bb12 and stored at 15° C.

| | 0 days | 6 days | 13 days | 19 days | 27 days |
|---|---|---|---|---|---|
| Treatment 1 | 7.82 ± 0.10 | 7.98 ± 0.07 | 7.76 ± 0.16 | 7.32 ± 0.13 | 6.01 ± 0.19 |
| | | | | *(p = 6E−4) | *(p = 6E−5) |
| | | | | ^{A} | ^{B}(p = 4E−9) |
| | | | | | ^{C}(p = 3E−3) |
| Treatment 2 | 8.00 ± 0.11 | 8.07 ± 0.08 | 7.94 ± 0.12 | 7.72 ± 0.19 | 6.31 ± 0.04 |
| | | | | ^{B}(p = 2E−3) | *(p = 4E−9) |
| | | | | | ^{B}(p = 2E−11) |
| | | | | | ^{D} |
| Treatment 3 | 8.03 ± 0.06 | 8.06 ± 0.06 | 7.89 ± 0.16 | 7.83 ± 0.19 | 7.55 ± 0.08 |
| | | | | ^{B}(p = 3E−4) | *(p = 5E−5) |
| | | | | | ^{A} |
| Treatment 4 | 8.04 ± 0.08 | 8.04 ± 0.12 | 7.91 ± 0.13 | 7.61 ± 0.10 | 6.21 ± 0.13 |
| | | | | *(p = 2E−3) | *(p = 2E−3) |
| | | | | ^{B}(p = 1E−3) | ^{B}(p = 3E−8) |

TABLE 2b
pH (± standard deviation) of orange juice inoculated with Bb12 and
stored at 15° C.

| | 0 days | 6 days | 13 days | 19 days | 27 days |
|---|---|---|---|---|---|
| Treatment 1 | 3.59 ± 0.01 | 3.57 ± 0.01 | 3.51 ± 0.04 | 3.56 ± 0.01 | 3.51 ± 0.02 |
| | | ^{B}(p = 2E−3) | | ^{B}(p = 1E−3) | |
| Treatment 2 | 3.60 ± 0.01 | 3.60 ± 0.03 | 3.50 ± 0.04 | 3.60 ± 0.01 | 3.50 ± 0.02 |
| | | | | ^{A} | |
| | | | | ^{C} | |
| Treatment 3 | 3.61 ± 0.02 | 3.63 ± 0.01 | 3.57 ± 0.05 | 3.65 ± 0.01 | 3.48 ± 0.02 |
| | | ^{A} | | ^{B}(p = 6E−5) | *(p = 8E−3) |
| | | | | ^{D}(p = 8E−4) | |
| Treatment 4 | 3.57 ± 0.02 | 3.57 ± 0.01 | 3.55 ± 0.05 | 3.60 ± 0.05 | 3.44 ± 0.04 |
| | | ^{B}(p = 3E−3) | | | *(p = 4E−3) |

TABLE 3a
Mean log cfu/ml (± standard deviation) of orange juice inoculated
with 338 and stored at 4° C.

| | 0 days | 7 days | 14 days | 21 days | 28 days |
|---|---|---|---|---|---|
| Treatment 1 | 7.52 ± 0.11 | 7.58 ± 0.04 | 7.64 ± 0.08 | 7.79 ± 0.13 | 7.71 ± 0.07 |
| | | ^{B}(p = 1E−3) | | | ^{B}(p = 6E−5) |
| Treatment 2 | 7.49 ± 0.11 | 8.14 ± 0.28 | 7.56 ± 0.01 | 7.74 ± 0.04 | 7.91 ± 0.03 |
| | | *(p = 7E−3) | *(p = 7E−3) | *(p = 1E−3) | *(p = 4E−5) |
| | | ^{A} | | | ^{A} |
| Treatment 3 | 7.33 ± 0.14 | 7.59 ± 0.10 | 7.64 ± 0.06 | 7.82 ± 0.10 | 7.66 ± 0.16 |
| | | ^{B}(p = 1E−3) | *(p = 2E−3) | *(p = 3E−4) | ^{B}(p = 0.003) |
| Treatment 4 | 7.35 ± 0.03 | 7.50 ± 0.10 | 7.54 ± 0.14 | 7.79 ± 0.10 | 7.83 ± 0.07 |
| | | ^{B}(p = 3E−4) | | *(p = 2E−4) | *(p = 5E−5) |

TABLE 3b
pH (± standard deviation) of orange juice inoculated with 338 and
stored at 4° C.

| | 0 days | 7 days | 14 days | 21 days | 28 days |
|---|---|---|---|---|---|
| Treatment 1 | 3.62 ± 0.02 | 3.47 ± 0.04 | 3.60 ± 0.01 | 3.61 ± 0.01 | 3.70 ± 0.01 |
| | | *(p = 0.003) | ^{A} | ^{A} | *(p = 1E−3) |
| | | | | | ^{A} |
| Treatment 2 | 3.60 ± 0.01 | 3.50 ± 0.03 | 3.61 ± 0.01 | 3.60 ± 0.01 | 3.70 ± 0.01 |
| | | | | ^{C} | *(p = 1E−4) |
| | | | | | ^{C} |
| Treatment 3 | 3.62 ± 0.01 | 3.59 ± 0.05 | 3.56 ± 0.02 | 3.73 ± 0.02 | 3.62 ± 0.01 |
| | | | *(p = 6E−3) | *(p = 9E−4) | ^{B}(p = 2E−4) |
| | | | | ^{B}(p = 7E−4) | ^{D}(p = 2E−4) |
| | | | | ^{D}(p = 6E−4) | |
| Treatment 4 | 3.58 ± 0.02 | 3.56 ± 0.04 | 3.52 ± 0.01 | 3.65 ± 0.02 | 3.62 ± 0.01 |
| | | | ^{B}(p = 1E−4)) | *(p = 1E−3) | ^{B}(p = 3E−4) |
| | | | | ^{B}(p = 1E−4) | ^{D}(p = 2E−4) |
| | | | | ^{D}(p = 9E−4) | |

TABLE 4a
Mean log cfu/ml (± standard deviation) of orange juice inoculated
with 338 and stored at 15° C.

| | 0 days | 10 days | 14 days | 21 days | 28 days |
|---|---|---|---|---|---|
| Treatment 1 | 7.52 ± 0.11 | 8.97 ± 0.15 | 8.71 ± 0.41 | 9.28 ± 0.33 | 9.16 ± 0.09 |
| | | *(p = 2E−6) | *(p = 2E−3) | *(p = 5E−8) | *(p = 5E−8) |
| | | ^{B}(p = 4E−3) | | | ^{B}(p = 7E−3) |
| Treatment 2 | 7.49 ± 0.11 | 9.00 ± 0.10 | 9.01 ± 0.17 | 9.44 ± 0.30 | 9.02 ± 0.21 |
| | | *(p = 2E−7) | *(p = 2E−6) | *(p = 1E−5) | *(p = 8E−6) |
| | | ^{B}(p = 8E−4) | | | |
| Treatment 3 | 7.33 ± 0.14 | 9.15 ± 0.10 | 8.69 ± 0.56 | 9.55 ± 0.32 | 9.15 ± 0.09 |
| | | *(p = 7E−7) | *(p = 5E−3) | *(p = 1E−5) | *(p = 6E−8) |
| | | ^{B}(p = 2E−3) | | | ^{B}(p = 9E−3) |
| Treatment 4 | 7.35 ± 0.03 | 8.65 ± 0.15 | 9.04 ± 0.09 | 9.52 ± 0.22 | 9.01 ± 0.06 |
| | | *(p = 2E−6) | *(p = 7E−9) | *(p = 7E−7) | *(p = 9E−10) |
| | | ^{A} | | | ^{A} |

TABLE 4b
pH (± standard deviation) of orange juice inoculated with 338 and
stored at 15° C.

| | 0 days | 7 days | 10 days | 14 days | 21 days | 28 days |
|---|---|---|---|---|---|---|
| Treatment 1 | 3.62 ± 0.02 | 3.47 ± 0.04 | 3.46 ± 0.02 | 3.40 ± 0.01 | 3.38 ± 0.02 | 3.29 ± 0.01 |
| | | *(p = 2E−3) | *(p = 3E−4) | *(p = 2E−5) | *(p = 4E−5) | *(p = 4E−6) |
| | | | | ^{A} | | |
| Treatment 2 | 3.60 ± 0.01 | 3.50 ± 0.03 | 3.48 ± 0.03 | 3.37 ± 0.02 | 3.36 ± 0.01 | 3.28 ± 0.02 |
| | | | | *(p = 3E−4) | *(p = 1E−4) | *(p = 1E−4) |
| | | | | | ^{A} | |
| Treatment 3 | 3.62 ± 0.01 | 3.59 ± 0.05 | 3.55 ± 0.04 | 3.36 ± 0.03 | 3.42 ± 0.01 | 3.27 ± 0.01 |
| | | | | *(p = 6E−5) | *(p = 2E−6) | *(p = 1E−6) |
| | | | | | ^{B}(p = 1E−3) | |
| Treatment 4 | 3.58 ± 0.02 | 3.56 ± 0.04 | 3.48 ± 0.04 | 3.33 ± 0.01 | 3.39 ± 0.02 | 3.30 ± 0.01 |
| | | | | *(p = 4E−5) | *(p = 4E−4) | *(p = 3E−5) |
| | | | | ^{B}(p = 2E−4) | | |

### Materials for Examples 2 to 5

### Orange Juice (OJ)

Kerry Ingredients supplied two batches of Dawn “Juicy Bits” OJ. All cartons were shipped in a silver-foil wrapped box and stored immediately at 4° C. on arrival.

### Apple Juice (AJ)

Kerry Ingredients supplied 3×1.89 litre plastic bottles of pasteurized White House™ Premium apple juice made from 100% pure apple juice (pressed from apples not from concentrate) and supplemented with vitamin C and calcium.

### Cranberry Juice (CJ)

Kerry Ingredients supplied 3×1.89 litre plastic bottles of Ocean Spray™ Cranberry Juice Cocktail containing 27% cranberry made from concentrate and juice, with added vitamin C and iron and filtered water.

In all experiments 100 ml samples were added to 100 ml screw-cap Duran glass bottles. For selective experiments 200 ml samples were stored in 200 ml bottles for sensory analysis. Bb12 was added at specified levels the same day samples were prepared.

### Gum Arabic (GA)

EmulGold™ in the form of powder was supplied and stored at room temperature. The powder was added directly to a number of samples based on a specified w/v concentration and mixed on a shaking platform for 30 min at room temperature. In all cases, the powder was added to ˜80 ml of juice and brought up to 100 ml following complete dissolution.

### Probiotic Culture Bb12

B. animatis subsp. lactis Bb12 was routinely cultured in Lactobacilli MRS medium (Difco, USA) supplemented with 0.05% (w/v) cysteine-hydrochloride (mMRS) and grown at 37° C. in an anaerobic work chamber (Ruskin in vivo 400, set at 8% hydrogen, 8% carbon dioxide and 84% nitrogen). Colonies were cultured on mMRS agar. For each batch of cells cultured prior to sample inoculation the following procedure was followed. Colonies were added to 10 ml mMRS broth and incubated for ˜24 hours. Using a 1% v/v inoculum a second broth culture was initiated and incubated for ˜20 hours or until the medium pH reached ˜4.2. A third broth culture was established using the same parameters and was found to yield ˜2×10⁹ cfu/ml. Based on this cell density a final volume was calculated depending on the required cfu/ml of fruit juice and the number of treatments. Cells were harvested by centrifugation washed twice in sterile water and re-suspended in sterile water from which 1 ml was used to inoculate 100 ml samples. This was estimated to yield ˜2×10⁷ cfu of probiotic per ml of sample. For other inoculation levels the culture was concentrated or further diluted to provide a constant 1 ml inoculation.

For each treatment three 100 ml fruit juice samples were prepared.

Colony Forming Units (cfu) per ml of OJ, AJ and CJ

Prior to analysis each 100 ml sample was shaken by hand. Approximately 8 ml of sample was poured into a sterile universal bottle within a laminar flow hood. The cfu/ml was determined for a 1 ml sample following serial dilution in MRD and pour plating with mMRS. Colonies were counted after 2 days incubation.

pH

The pH of all samples was determined using a Mettler Toledo pH meter calibrated prior to each series of measurements. Following the removal of 1 ml for cfu/ml analysis samples were allowed to reach room temperature before a pH measurement was taken.

### Storage Index, Percent Survival and Fold Change in Survival

To allow a comparison between treatments a storage index (SI) was established based on the number of days required to yield a 0.5 log reduction in cell density from that measured on the first day of sampling. In addition, the percent survival at the last day of storage was compared. This was determined by dividing the cfu/ml on the last day by the cfu/ml of the first sample ×100. By directly comparing the treatment percent survival with the respective control a fold change in survival following the inclusion of the powder was determined.

### Statistical Comparisons

A mean cfu/ml value and standard deviation (SD) based on triplicate analysis was established and all statistical evaluations were based on the Student's t-Test 2-tail paired for comparison between the same samples at different times and 2-tailed unpaired for comparisons between samples from different treatments. Significances were measured at a probability level p<0.05.

All SI data is presented in Table 5. Percent survival and fold change in survival are given in Table 6.

### Example 2

### Varying EmulGold Concentrations and Survival of Bb12 in OJ

### Cell Viability

Using an inoculation level of 1E+08 cfu/ml for Bb12 it was shown that the strain remained stable in OJ stored at 4° C. with no decline in viability over the test period of 28 days. It was also shown, however, that with an extended storage period a gradual decline was recorded with an SI of 49 days (Table 5).

It was further shown that the inclusion of 3% w/v EmulGold improved survival when OJ was stored at 15° C. and this was attributed to a protective mechanism which was effective when cells became stressed by the storage conditions. Similarly in this study at storage times when Bb12 viability fell in control OJ samples the inclusion of EmulGold over a range of concentrations improved survival with SI increases of between 8 and 15 days (Table 6). All treatments had a statistical significant higher cfu/ml count on the last sample day compared to the control (Table 6). Taking ΔSI, percent survival and fold increase in survival into consideration the inclusion of EmulGold at 5% w/v appeared to confer the greatest degree of protection. However, compared to the other doses only a statistical significant increase over the 1% w/v treatment was recorded.

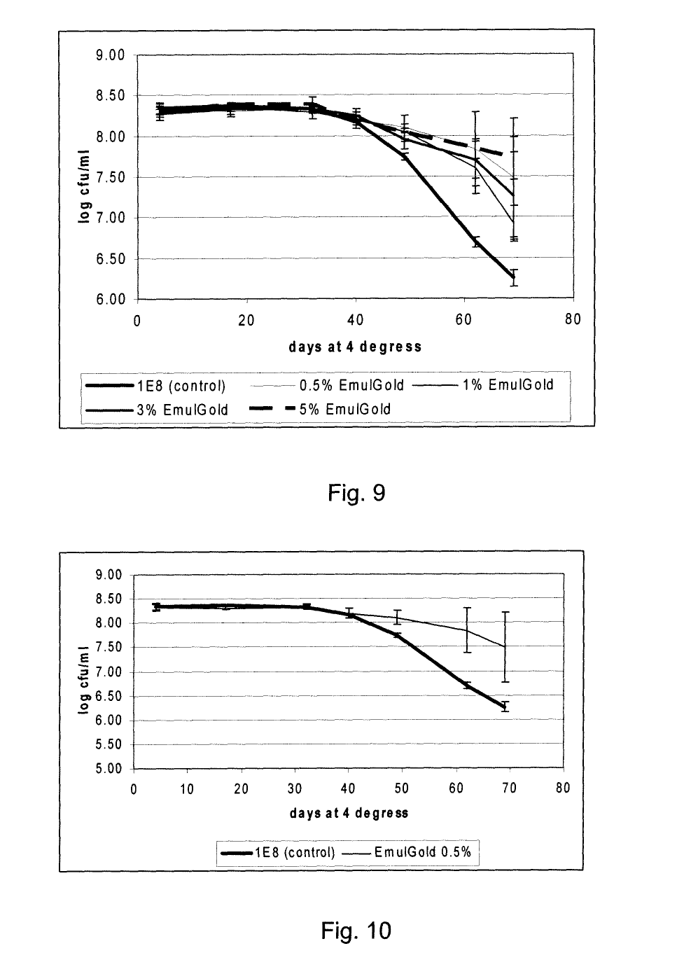

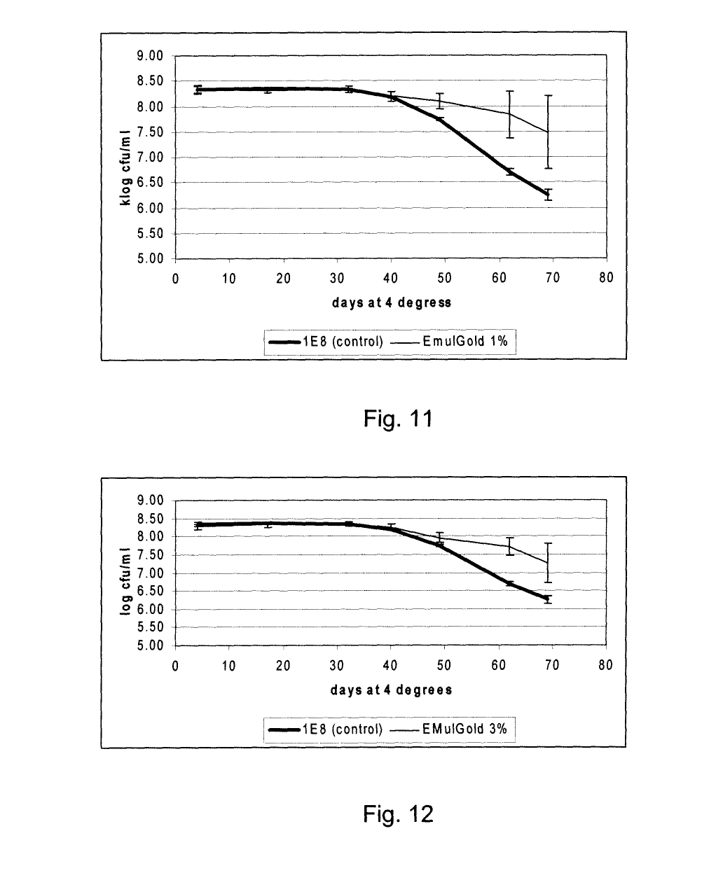

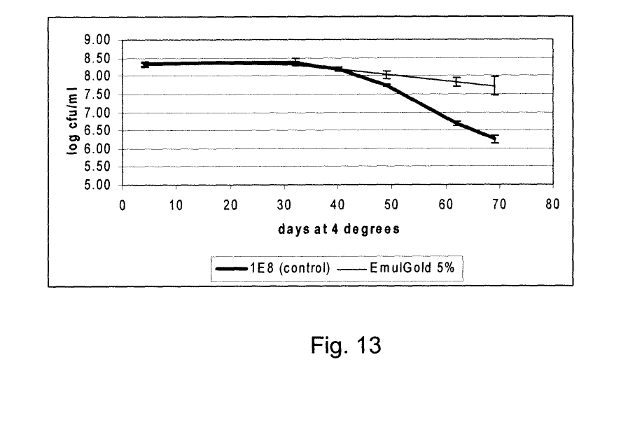

Interestingly, in the EmulGold containing treatments the variation between the samples, once Bb12 levels started to decline was markedly higher than those observed for the controls. The results for all viability are shown in FIGS. 9 to 13.

pH

The pH values of OJ increased slightly with the addition of 3% and 5% w/v EmulGold but for 0.5% and 1% additions no differences were apparent. A possible dose effect was evident with the highest pH values (3.72-3.78) always associated with the 5% w/v concentration, which were between 0.03 and 0.06 pH units higher than the control. The relative differences between the orange juices with and without EmulGold were maintained although the absolute values did fluctuate during the course of the experiment. These changes were also seen in the control treatments and although the pH meter was calibrated before each series of measurements changes may be an artefact reflecting the accuracy over the pH range and consistency between the times measured.

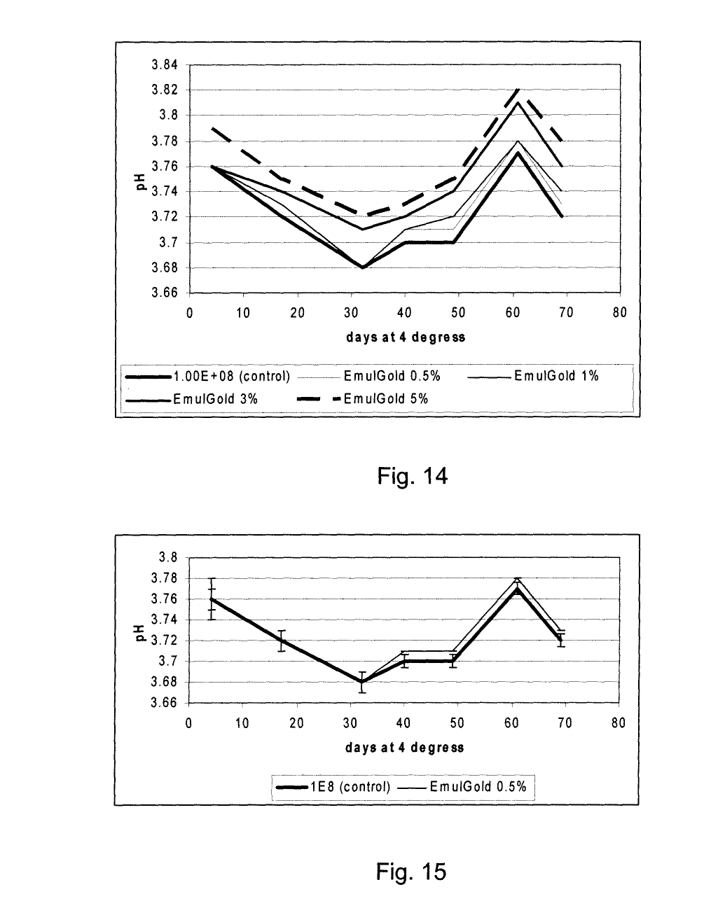

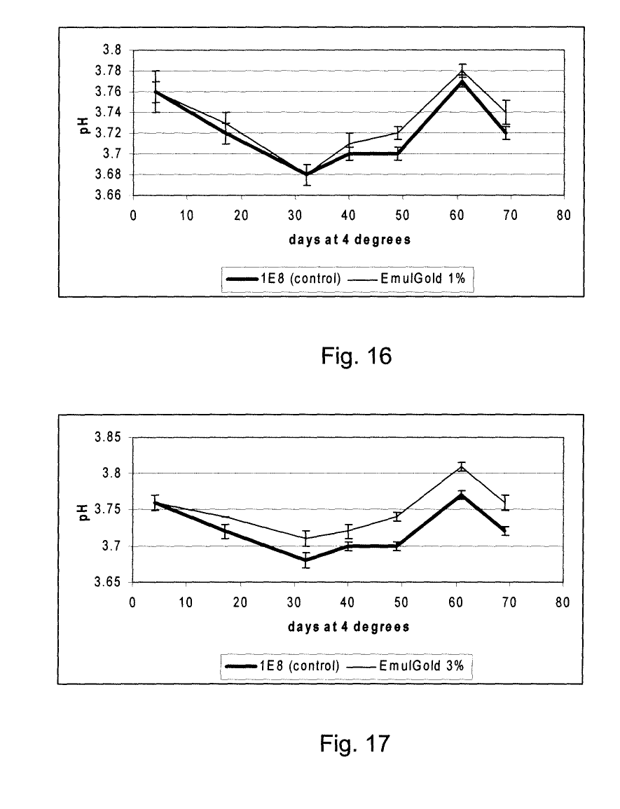

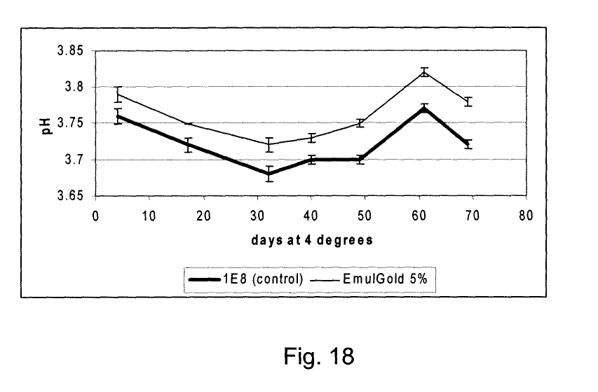

The results for pH are shown in FIGS. 14 to 18.

### Example 3

### Varying Bb12 Inoculation Level in OJ with and without EmulGold

### Cell Stability

The inclusion of 3% EmulGold again resulted in a consistent increase in Bb12 survival for all samples irrespective of the starting inoculation level. The SI values increased in all cases by between 4 and 8 days, although there was no clear trend with 1E+07 being less than 1E+06 and 1E+08 (Table 5). Based on fold increase in survival all EmulGold treatments were again effective but a trend was also evident with the level of protection being inversely proportional to the level of Bb12 inoculation (Table 6).

A marked increase in the SD for the EmulGold treatments once Bb12 viability began to fall was again observed and this affected the statistical comparisons for 1E+07 and 1E+09 treatments with probabilities greater than 0.05 despite clear differences between the final cfu/ml counts and the respective controls. At the other inoculation levels a statistical significant improvement was observed.

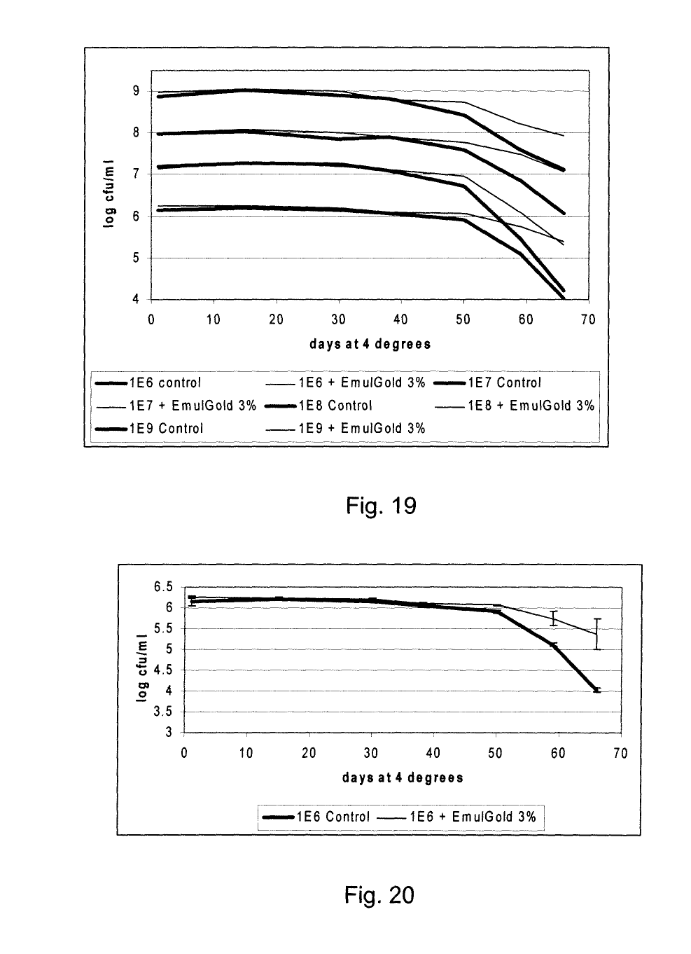

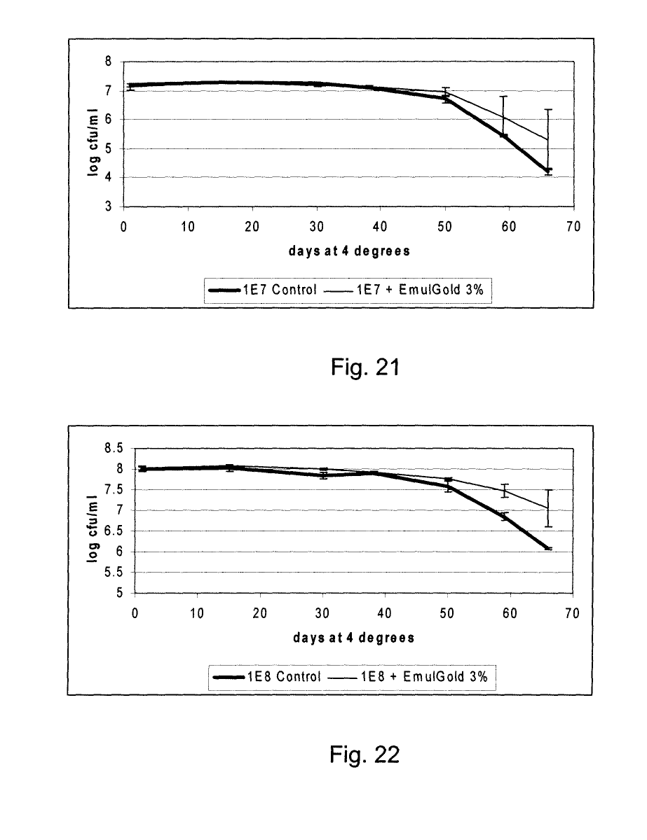

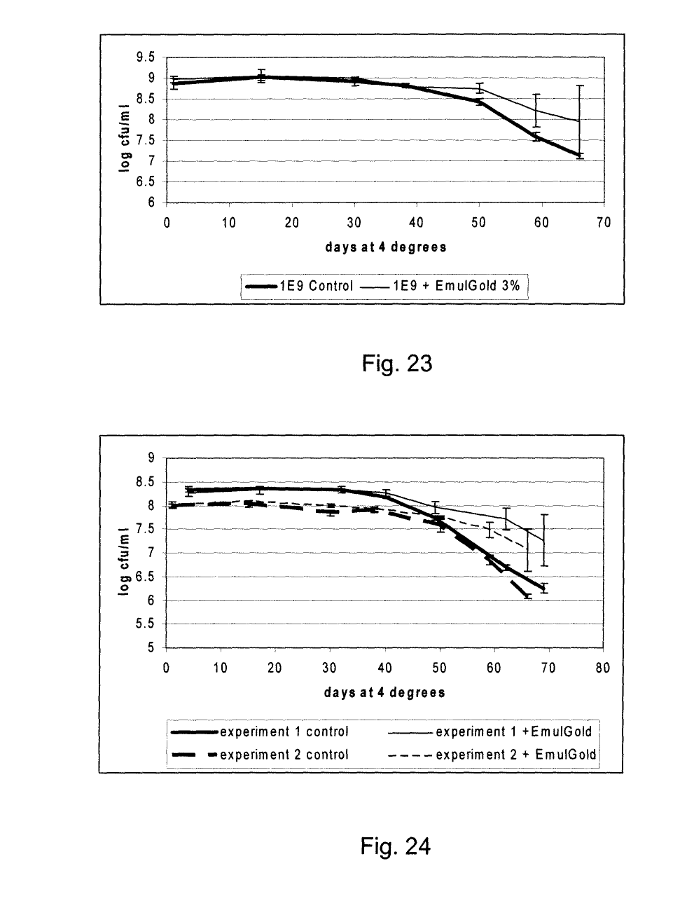

The comparable control and 3% treatment in Example 2 yielded similar results. For Example 2 and 3 the control SI and percent survival were 49 and 51 days and 0.7 and 1.2%, respectively. Similarly for 3% EmulGold the SI values were 57 and 59 days, ΔSI+8 and +8, percent survival 9.8 and 11%, and fold increase in survival 14 and 9. The results for cell stability are shown in FIGS. 19 to 24.

pH

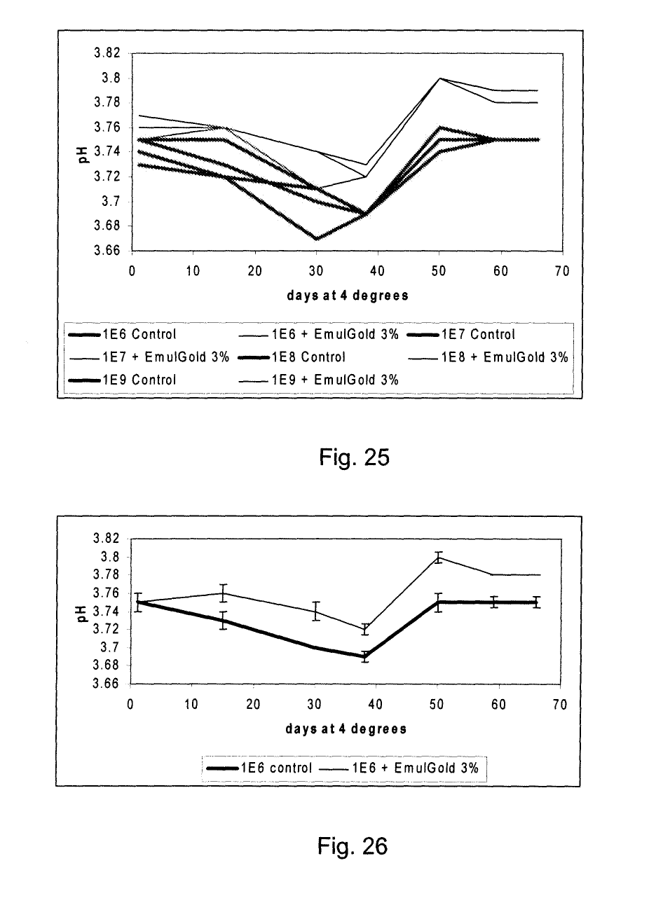

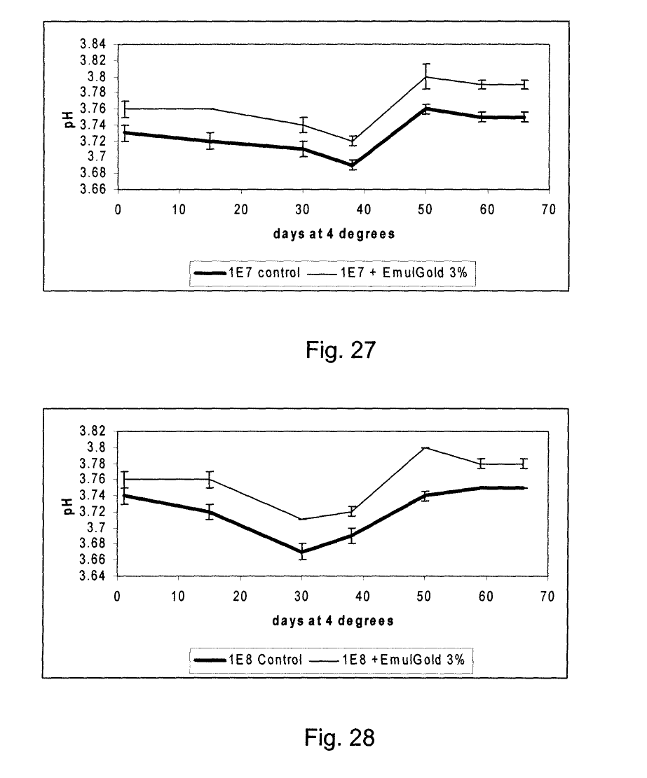

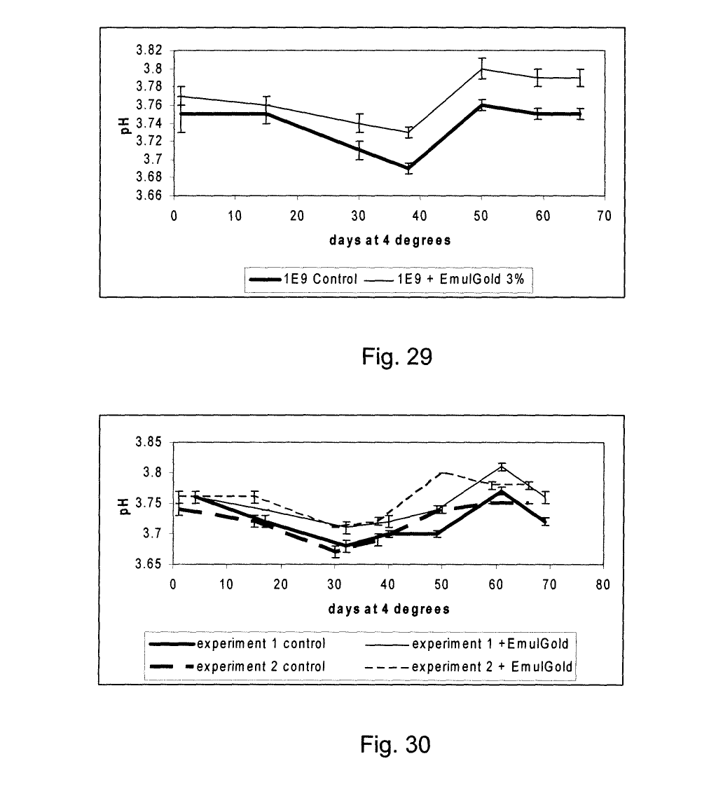

The pH values associated with each treatment showed a slight but consistent increase from ˜pH 3.74 to ˜3.76 with the addition of 3% w/v Emulgold. The level of inoculation did not appear to effect pH. Again fluctuations in values during the experiment may reflect the accuracy of the pH meter, with absolute differences on a given day being maintained. Based on the common treatments from Examples 2 and 3 the reproducibility of the measurements appears to be good. However, the values were generally taken no more than 1 day apart which might explain the similar pH profiles. The results for pH are shown in FIGS. 25 to 30.

### Example 4

### Bb12 in Apple Juice with and without EmulGold or KLTA

### Cell Viability

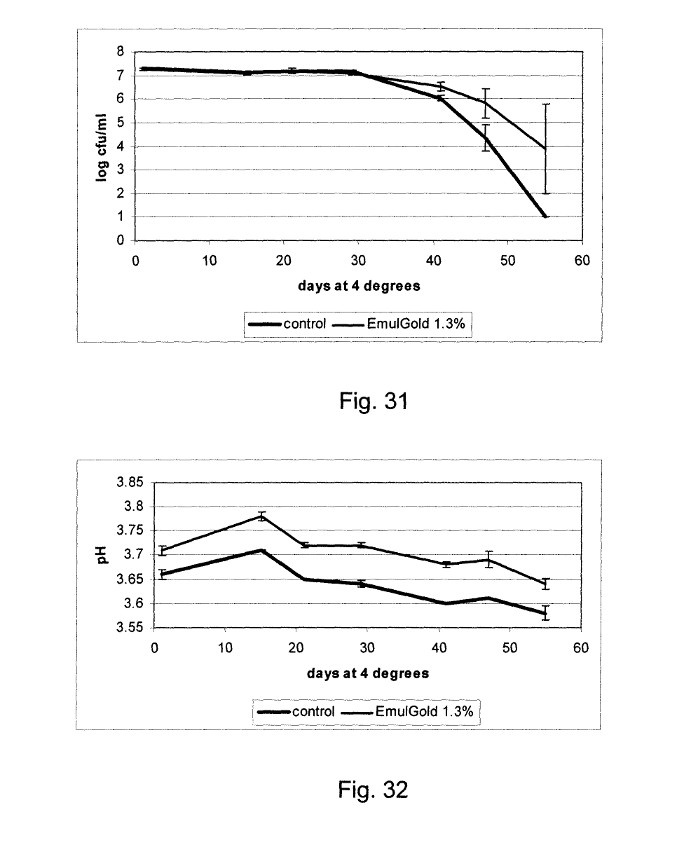

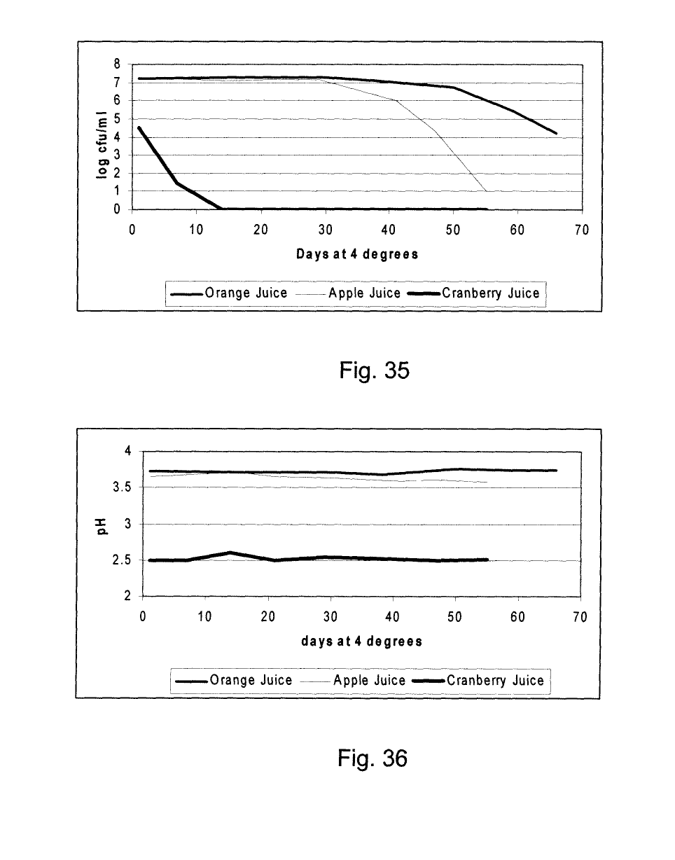

Bb12 viability in AJ was clearly reduced compared to OJ with a SI of 33 days and almost complete cell loss after 55 days. EmulGold produced a slight increase in SI to 36 days (Table 5). However, their protective effect was much more evident based on their overall survival values of 0.04 and 0.1%, respectively (Table 6). These represented 8000 and 20000 fold increases above the control. Again at later times the SD was higher for the powder treatments than the equivalent controls, indicating a protective mechanism operates. A better level of protection may result with the inclusion of either powder at higher concentrations. The results for cell viability are shown in FIGS. 31 and 35.

pH

The pH of the apple juice samples were lower than those recorded for orange juice by an average of ˜0.1 log. The addition of EmulGold resulted in a slight increase in pH of ˜0.05 logs which was comparable to that seen for orange juice at higher powder concentrations. Again fluctuations in pH were observed over the course of the experiment but the relative difference with the control was maintained. The results for pH are shown in FIGS. 32 and 36.

### Example 5

### Bb12 in Cranberry Juice with and without EmulGold

### Cell Viability

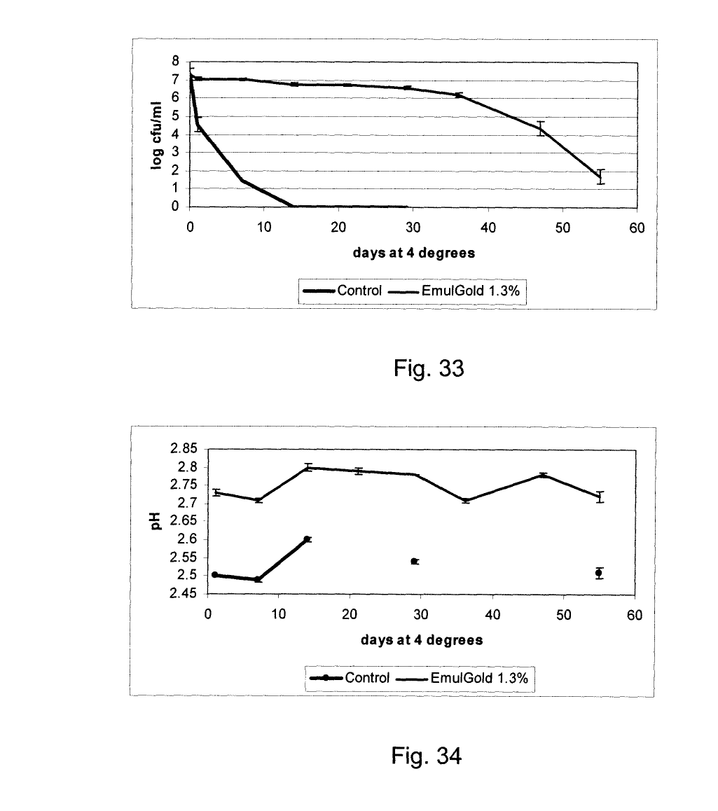

Bb12 viability in cranberry juice was extremely poor with a SI of less than a day (Table 5). Indeed by day 1 the cfu/ml had declined by 3 logs (Table 6). For the same inoculation level in OJ and AJ the same overall decline would have taken ˜66 and 50 days, respectively. With the inclusion of EmulGold at 1.3% w/v the SI value was 35 days. It is unclear if Emulgold protects by a similar mechanism. However, the SD did not increase during the decline of Bb12 viability and it is tempting to suggest that the mechanism of protection is different to that which operates in OJ and AJ. Red coloured juices are known to contain specific antimicrobial component, such as, polyphenols and may play a role and provide an alternative cause of cell death. This could explain why no increase was observed in the SD of EmulGold treatments compared with the control. The results for cell viability are shown in FIGS. 33 and 35.

pH

The pH of cranberry juice was lower than that recorded for OJ juice by ˜1.2 log units. The addition of EmulGold resulted in an increase in pH of ˜0.2 log units, which was relatively higher than the increases seen for both AJ and OJ. However, the level was still considerably lower than those for OJ or AJ. The results for pH are shown in FIGS. 34 and 36.

The study showed that EmulGold effectively protects Bb12 in OJ stored for over 40 days at 4° C. There was some indication that the lower inoculation levels were more effectively protected based on their fold increase in survival. Similarly there was evidence that EmulGold protected better at 5% w/v compared to lower concentrations.

There was a consistent trend for relatively large variations between repeat samples for EmulGold treatments during the final stages of storage in orange and apple juice, which restricted statistical analysis. The resulting higher SD could indicate that once Bb12 viability begins to decline the protection is rapidly lost or that other causes of cell death take effect.

Compared to OJ the survival of Bb12 in AJ was reduced and was extremely poor in CJ. EmulGold again provided protection although the relative level of protection was much more evident in CJ. For CJ samples a remarkable improvement in Bb12 viability was observed. Interestingly, the SD observed for protected CJ treatments, even during Bb12 decline, was comparable to those of the control treatments. This suggests that a different protective mechanism operates to that seen in OJ and AJ.

The inclusion of the powders at 3% w/v or above increased the pH of OJ, lower concentrations increased AJ and CJ pH. The natural pH of AJ was slightly lower than that of OJ but CJ was considerably lower again. The inclusion of EmulGold resulted in a relatively higher increase in CJ pH than that seen for OJ or AJ.

On the basis of the trials carried out it is postulated that the main cause of loss of activity of Bb12 in fruit juices is organic acid which diffuses into the cells during prolonged storage. At some point intracellular pH attains a level that cannot be reduced sufficiently once the cells are allowed to grow and this adversely affects cell viability. It has been found that gum Arabic protects the cells by reducing the rate at which acid moves into the cell. This could be achieved by either forming a barrier at the cell surface or by altering the chemistry of the organic acid. Either mechanism is eventually lost and results in a rapid increase in intracellular pH and a subsequent accelerated loss in viability when cells are cultured. Time at which protection fails has been found to be variable and because loss is also associated with accelerated cell death a relatively large variation between replicates occurs.

In apple juice there is a higher level of organic acid which results in a shorter period of storage viability and length of protection. In cranberry juice the concentration of organic acids is further increased and results in an even higher rate of cell death than that seen in AJ controls. However, before barrier integrity is lost and the effect of acid is felt other “non-acid based antimicrobials”, such as polyphenols, build-up in the cells during storage and reduce cell viability either directly or through a reduced capacity to control intracellular pH.

TABLE 5
Days to attain a 0.5 log cfu/ml reduction (SI) for Bb12 stored at
4° C. in fruit juice with or without powder supplements.

| | Approx start | | | |
|---|---|---|---|---|
| Juice | cfu/ml | SI | SI (% w/v powder) | ΔSI |
| OJ | 1E+08 | 49 | 59 (0.5% EmulGold) | +10 |
| OJ | 1E+08 | 49 | 57 (1% EmulGold) | +8 |
| OJ | 1E+08 | 49 | 57 (3% EmulGold) | +8 |
| OJ | 1E+08 | 49 | 64 (5% EmulGold) | +15 |
| OJ | 1E+06 | 54 | 60 (3% EmulGold) | +6 |
| OJ | 1E+07 | 51 | 55 (3% EmulGold) | +4 |
| OJ | 1E+08 | 51 | 59 (3% EmulGold) | +8 |
| OJ | 1E+09 | 51 | 55 (3% EmulGold) | +4 |
| AJ | 1E+07 | 33 | 36 (1.3% EmulGold) | +3 |
| CJ | 1E+07 | 1 | 35 (1.3% EmulGold) | +34 |

TABLE 6
Final reduction in Bb12 cfu/ml, percent survival and fold change in
survival following storage at 4° C. in fruit juice with or without
Emulgold powder supplements

| | | | | | Expt. | | | |
|---|---|---|---|---|---|---|---|---|
| | Approx start | | ^{G}Log fall | | % w/v | ^{G}Log fall | | ^{I}Fold |
| Juice | cfu/ml | Expt | (day) | %^{G} | powder | (day) | ^{H}% | change |
| OJ | 1E+08 | E | 2.09 (69) | 0.7 | A. 0.5 | 0.84* (69) | 14.5 | +21 |
| OJ | 1E+08 | E | | | B. 1 | 1.38* (69) | 4.2 | +6 |
| OJ | 1E+08 | E | | | C. 3 | 1.01* (69) | 9.8 | +14 |
| OJ | 1E+08 | E | | | D. 5 | 0.58* (69) | 26 | +37 |
| OJ | 1E+06 | I | 2.14 (66) | 0.7 | F. 3 | 0.88* (66) | 13.2 | +19 |
| OJ | 1E+07 | J | 2.99 (66) | 0.1 | G. 3 | 1.83 (66) | 1.5 | +15 |
| OJ | 1E+08 | AB | 1.91 (66) | 1.2 | AA. 3 | 0.96* (66) | 11 | +9 |
| OJ | 1E+09 | K | 1.85 (66) | 1.8 | H. 3 | 1.03 (66) | 9.3 | +5 |
| AJ | 1E+07 | R | 6.30 (55) | 5E−06 | P. 1.3 | 3.37* (55) | 0.04 | +8000 |
| AJ | 1E+07 | R | | | Q. 1.3 | 3.01* (55) | 0.1 | +20000 |
| CJ | 1E+07 | U | 4.54 (13) | 0 | S. 1.3 | 0.52* (14) | 30 | |
| CJ | 1E+07 | U | | | T. 1.3 | 0.31* (14) | 49 | |

^{G}Log cfu/ml fall compared to first sample
^{H}% survival = cfu per ml at last sample point/cfu per ml first sample point × 100
^{I}Fold Change in survival = % survival in juice plus powder sample/% survival in equivalent control juice sample
*Statistically significant at p < 0.05 compared to control treatment

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail within the scope of the claims.

1. A probiotic composition comprising a probiotic culture having a probiotic count of between 10⁶ and 10¹⁰ cfu/ml or cfu/g and a carrier medium;
characterised in that:
the probiotic composition further comprises between 0.1% and 99.9% gum Arabic by weight to result in a probiotic culture that is stable at a pH of 4 or less.

2. A probiotic composition as claimed in claim 1, wherein the gum Arabic has a viscosity in the region of between 20 and 200 cP at 25% (w/w) solution and 25° C. in an aqueous solution as measured at a shear rate of between 0.1 s⁻¹ and 1000 s⁻¹.

3. A probiotic composition as claimed in claim 1, wherein:
the carrier medium comprises one or more of MRS broth, mMRS solution, and water; and
the gum Arabic is in the amount of between 30% and 99% by weight.

4. A probiotic composition as claimed in claim 1, for addition to a beverage or food product having a pH of 4 or less than 4 in an amount sufficient to provide between 0.1 and 10% gum Arabic by weight of the product.

5. A probiotic composition as claimed in claim 1, wherein the carrier medium is a beverage or food product having a pH of 4 or less than 4 and the gum Arabic is in the amount of between 0.1 and 10% by weight.

6. A probiotic composition as claimed in claim 5, wherein the gum Arabic is in the amount of between 0.5 and 5% by weight.

7. A probiotic composition as claimed in claim 1, wherein the probiotic culture has a probiotic count of between 10⁷ and 10⁹ cfu/ml or cfu/g.

8. A probiotic composition as claimed in claim 1, wherein the probiotic culture comprises one or more of Bifidobacterium animalis, Bifidobacterium adolescentis, Bifidobacterium bifidum, Bifidobacterium breve, Bifidobacterium essensis, Bifidobacterium infantis, Bifidobacterium lactis, Bifidobacterium longum, Lactobacillus paracasei, Lactobacillus acidophilus, Lactobacillus delbrueckii subsp. bulgaricus, Lactobacillus casei, Lactobacillus crispatus, Lactobacillus johnsonii, Lactobacillus lactis, Lactobacillus fermentum, Lactobacillus plantarum, Lactobacillus rhamnosus, Lactobacillus reuteri, Lactobacillus salivarius, Lactobacillus amylovorus, Lactobacillus gasseri, Lactobacillus pentosaceus, Enterococcus faecalis, Enterococcus faecium, Pediococcus acidilactici, Propioniobacterium freundenreichii, Saccharomyces boulardii and Streptococcus thermophilus.

9. A probiotic beverage or food product comprising the probiotic composition as claimed in claim 1.

10. A probiotic beverage or food product as claimed in claim 9, wherein the probiotic beverage or food product comprises one or more of fruit juices, fruit drinks, fruit juice, fruit drink or fruit containing products such as mixed fruit juice/dairy drinks, mixed fruit juice/non-dairy drinks, mixed fruit juice/dairy food products, mixed fruit juice/non-dairy food products, mixed fruit drink/dairy drinks, mixed fruit drink/non-dairy drinks, mixed fruit drink/dairy food products, mixed fruit drink/non-dairy food products, mixed fruit/dairy drinks, mixed fruit/non-dairy drinks, mixed fruit/dairy food products, and mixed fruit/non-dairy food products.

11. A process for preparing a probiotic composition comprising a probiotic culture and a carrier medium, wherein the probiotic culture comprises harvested cells; and the harvested cells have a probiotic count of between 10⁶ and 10¹⁰ cfu/ml or cfu/g, the process comprising:
dissolving between 0.1% and 99.9% gum Arabic by weight in the carrier medium to provide a gum Arabic solution; and
adding the probiotic culture to the gum Arabic solution to provide the probiotic composition.

12. (canceled)

13. (canceled)

14. A process for preparing a probiotic culture as claimed in claim 11, wherein the carrier medium comprises one or more of MRS broth, mMRS solution, and water.

15. A process as claimed in claim 11, wherein the probiotic composition is subsequently added to a food or beverage product having a pH of 4 or less than 4.

16. A process for preparing a probiotic culture as claimed in claim 11, wherein the carrier medium is a beverage or food product having a pH of 4 or less than 4.

17. A composition comprising a probiotic culture and gum Arabic, the composition having a pH of 4 or less than 4.
